(19) United States
(12) Patent Application Publication
(10) Pub. No.: US 2006/0227855 A1
(43) Pub. Date: Oct. 12, 2006

(54) Method and device of cell search for mobile terminal in tdd-cdma system

(76) Inventors: Luzhou Xu, Shanghai (CN); Dong Wang, Shanghai (CN); Pu Xu, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/540,677

(22) PCT Filed: Dec. 18, 2003
(86) PCT No.: PCT/IB03/06129

§ 371 Date: Apr. 14, 2006

(30) Foreign Application Priority Data
Dec. 30, 2002 (CN) 02160459.2

(51) Int. Cl. H04B 1/00

(52) U.S. Cl. 375/149

(57) ABSTRACT

A cell-searching method and device for a mobile terminal in TDD-CDMA system, in which the mobile uses the special power pulse of using the downlink pilot slot (DwPTS) to acquire coarse synchronization before using conventional correlation cell searching to refine the search. Due to the coarse synchronization, the conventional correlation cell search can be limited to a narrow time window. So the cell searching complexity and searching time in the TDD-CDMA system, especially TD-SCDMA decrease greatly.

### BACKGROUND OF THE INVENTION

This invention relates to mobile communication system, more particularly, relates to the method and device of cell search for mobile terminal in TDD-CDMA system.

In CDMA wireless communication system, cell searching must be performed when mobile terminals establish initial synchronization (initial capture) or the cell is switched due to the motion of the mobile terminal.

In DS-CDMA system including WCDMA/FDD, WCDMA/TDD and TD-SCDMA, some special synchronization signals must be applied, such as SCH in WCDMA and SYNC_DL in TD-SCDMA. These signals are transmitted by base station in downlink, by which mobiles establish and keep synchronization with base station.

At present, most methods for cell searching make use of the autocorrelation characters of synchronization codes. FIG. 1 is a block diagram showing how to realize cell searching by using the correlator. Synchronization codes generator 10 generates local synchronization codes, which are sent to correlator 12 together with the received signals. According to the autocorrelation characters of synchronization codes, integrator 121 in correlator 12 will send a peak value when synchronization codes generated at local area match with the received signals (In other words, the two have the same signal sequence and phase). Otherwise, correlator 12 will output a smaller value. Controller 11 is used to control sequences and phases of local synchronization codes. In order to search the peak value sent by it, correlator 12 must scan all possible sequences and phases of synchronization codes. For example, there are 32 different kinds of SYNC-DL sequences. However, the searching window of SYNC-DL is a subframe, namely 6400 code pieces, which means that there are at least 6400 possible phases. Therefore, the correlate operation has to be performed 302800 (6400×32) times.

In order to decrease the cell searching time, lots of arithmetic and methods have been put forwards, such as the method of using several parallel correlators, referring to FIG. 5 in A method and device of cell search in asynchronous communications system, international publication number WO00/67396. However, more hardware resources are needed to apply these methods.

FIG. 2 is a block diagram showing the standardized subframe structure of TD_SCDMA. The length of subframe is 5 ms, namely 6400 code pieces. Every frame is divided into seven main time slots (TS), the length of which is 675 us, and three special time slots: downlink pilot time slots (DwPTS) with 96 code pieces, guard period (GP) with 96 code pieces, and uplink pilot time slots (UpPTS). The length of the routine time slot (including Td and Tu) is 0.675 ms, namely 864 code pieces. The last 16 code pieces are regarded as guard period (GP).

DwPTS can be used as the downlink pilots and synchronization channel, which is transmitted by the base station (NodeB) at full power. This time slot is composed of SYNC_DL with 64 code pieces and the guard period with 32 code pieces. The content of SYNC_DL is a group of Gold code. UpPTS can be used as pilots of the uplink and synchronization channel. It is generally composed of SYNC_UP with 128 code pieces and the guard period with 32 code pieces. The time slot in guard period is used as the conversion point of the base station (NodeB). The length of the time slot is 75 us (95 code pieces).

As discussed earlier, there is a guard period with 48 code pieces before the synchronization signal (SYNC_DL), and a guard period with 96 code pieces after it. In order to conquer the disturbing of multiple accessing, base stations and mobile terminals will keep the off state in these guard periods, which means they do not send signal. FIG. 3 is a graph showing the pulse power of a subframe in TD-SCDMA system. It can be seen from the graph that there are power depression in the guard period.

Moreover, in TD-SCDMA system, SYNC_DL is required to be sent at full power. This means that the intensity of SYNC_DL is always greater than the intensity of noise, and therefore the SYNC_DL can be detected. FIG. 4 gives an example showing the power pulse of DwPTS: there is a relatively long guard period (namely power depression) both in the beginning and at the end of a power pulse with 64 code pieces. Furthermore, in the subframe of TD-SCDMA, this power pulse with 64 code pieces appears only once. Therefore, we can acquire coarse synchronization through searching this unique power pulse with 64 code pieces of SYNC_DL.

### SUMMARY OF THE INVENTION

This invention provides a method of cell search for mobile terminal in TDD-CDMA system. In this method, coarse time synchronization will be acquired by searching the power pulse of downlink synchronization signal. Based on the coarse time parameter, a time searching window will be opened, in which the downlink synchronous signals will be searched by the traditional correlation method. Therefore, the conventional correlation cell search in the present invention can be limited in a narrow time window instead of a whole time window, so that the searching time can be decreased.

The invention is realized as follows:

A method of cell search for mobile terminal in TDD-CDMA system, which including the following steps:

a. searching the signal transmitted by base station according to pulse power;

b. if a signal similar to downlink synchronization signal is found successfully, a coarse time synchronization parameter is achieved;

c. based on the coarse time synchronization parameter, open a time searching window, and search for the downlink synchronous signals in this time window;

d. if it is failed to find a downlink synchronous signal in step c, search downlink synchronous signals in the whole time period.

Wherein, step a further includes the following steps:

a1. defining a matched template;

a2. calculating the power of received signals;

a3. comparing all the received signals with the said matched template.

The parameters of the matched templates are defined as follows:

H1 is the power threshold of guard period of the matched template; H2 is the power threshold of downlink synchronous signal of the matched template; L1 is the length of the guard period of the matched template; L3 is the length of the downlink synchronous signal of the matched template.

In step a2, the pulse power of the signal can be achieved by the real part and the image part of the signal.

In Step a3, a variable of credit is defined, which is used to measure the similarity between the received signals and the matched template. And judgment can be made through the variable of credit: if the variable of credit reaches the specified threshold, it is judged that the downlink synchronous signal is found.

Step a3 further includes the following steps:

a3-1. detecting guard period prior to signal pulse;

a3-2. detecting signal pulse period;

a3-3. detecting guard period post signal pulse.

Detecting guard period prior to signal pulse includes: comparing the signal pulse power with H1, if the signal pulse power is lower than H1, the variable of credit increases a specified value; otherwise, the variable of credit decreases a specified value. Detecting signal pulse period includes: comparing the signal pulse power with H2, if the signal pulse power is higher than H1, the variable of credit increases a specified value; otherwise, the variable of credit decreases a specified value. Detecting guard period post signal pulse includes: comparing the signal pulse power with H1, if the signal pulse power is lower than H1, the variable of credit increases a specified value; otherwise, the variable of credit decreases a specified value.

In every pulse period of step a3, the comparison between received signal pulse power and the power of matched template will be made at every time point, or at several preset detection points.

The benefit of the present invention is: searching the power pulse of downlink synchronization signal to acquire a coarse time synchronization parameter before searching for the downlink synchronous signals in the traditional correlation way, and then performing the conventional correlation search in the time window based on the coarse time. Therefore, the searching time for downlink synchronization signal and the conventional searching complexity will be decreased greatly.

### BRIEF DESCRIPTION OF THE DRAWINGS

FIG. 1 is an explanatory diagram showing a correlator for cell searching;

FIG. 2 is an explanatory diagram showing the structure of subframes in TD_SCDMA system;

FIG. 3 is a graph showing the power pulse of frames in TD-SCDMA system;

FIG. 4 is a graph showing the power pulse of DwPTS;

FIG. 5 is a flowchart showing the power pulse detecting method of cell search;

FIG. 6 is an explanatory diagram showing a matched template of the power pulse of downlink synchronization signal SYNC_DL;

FIGS. 7(a) and (b) is a flowchart showing a method for detecting the power pulse;

FIGS. 8(a) and (b) is a flowchart showing a simplified method for detecting the power pulse;

FIG. 9 is a block diagram showing the structure of the mobile terminal including the cell search device of TDD_CDMA system; and

FIG. 10 is a block diagram showing the structure of cell search device in TDD_CDMA system.

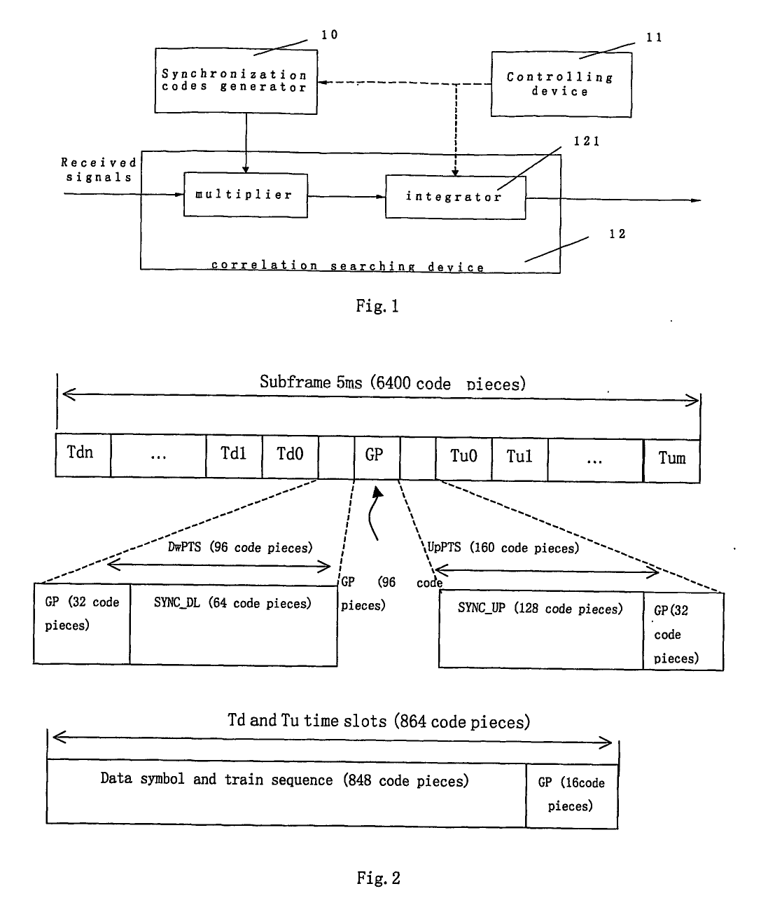

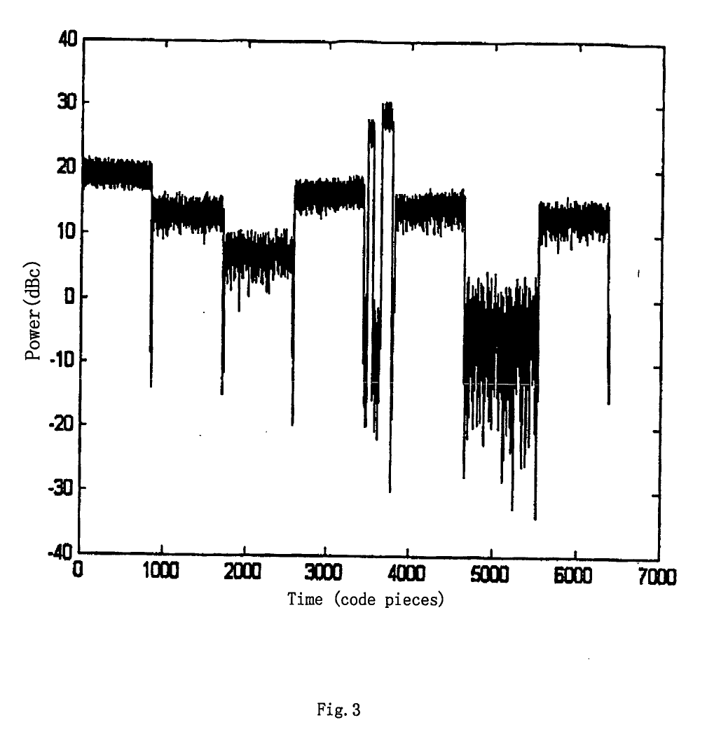

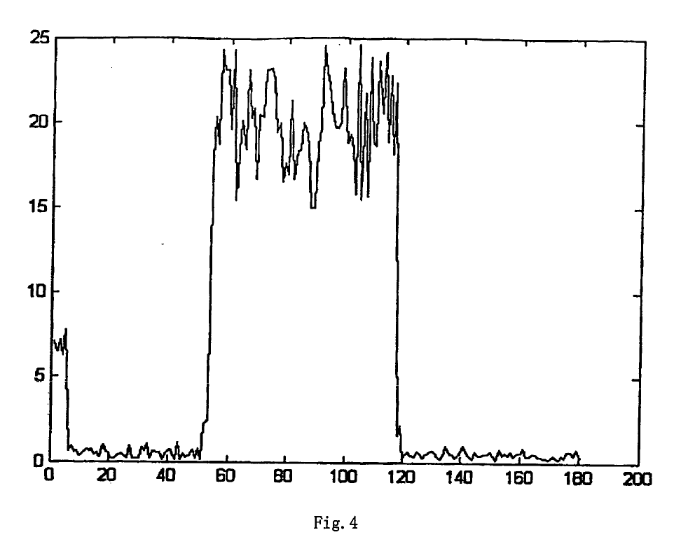

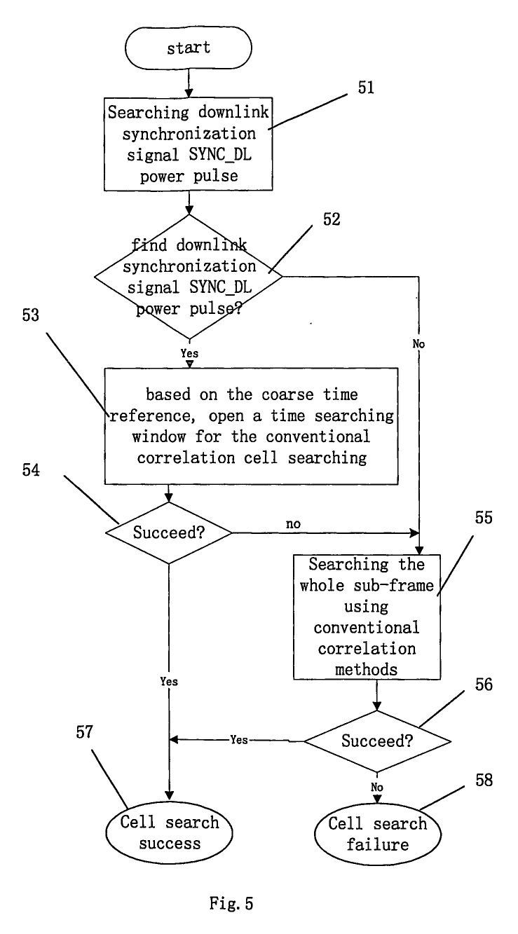

### DETAILED DESCRIPTION OF THE PREFEERED EMBODIMENTS

A detailed description of this invention will be given in the light of the attached drawings.

FIG. 5 is a flowchart showing the method of this invention.

Mobile searches downlink synchronization signal SYNC_DL power pulse (step 51), whose character is that the power pulses with 64 code pieces having long guard periods at the both ends of it.

Judging whether the downlink synchronization signal SYNC_DL power pulse is found (step 52), if it is found successfully, a coarse time synchronization parameter will be gained. Based on the coarse time parameter, a time searching window will be opened, in which the downlink synchronization signal SYNC_DL will be searched using the conventional correlation methods (step 53). Judging whether the searching is successful, if it is succeed to find a downlink synchronization signal, finish searching. If failed, then search the whole sub-frame for downlink synchronization signal SYNC_DL using the conventional correlation methods (step 55).

If failed in searching SYNC_DL power pulse, then search the whole sub-frame for the downlink synchronization signal SYNC_DL using conventional correlation methods too (step 55). Judging whether it is succeed in searching, if succeeds, then cell search succeed (step 57). Otherwise, cell search failed (step 58).

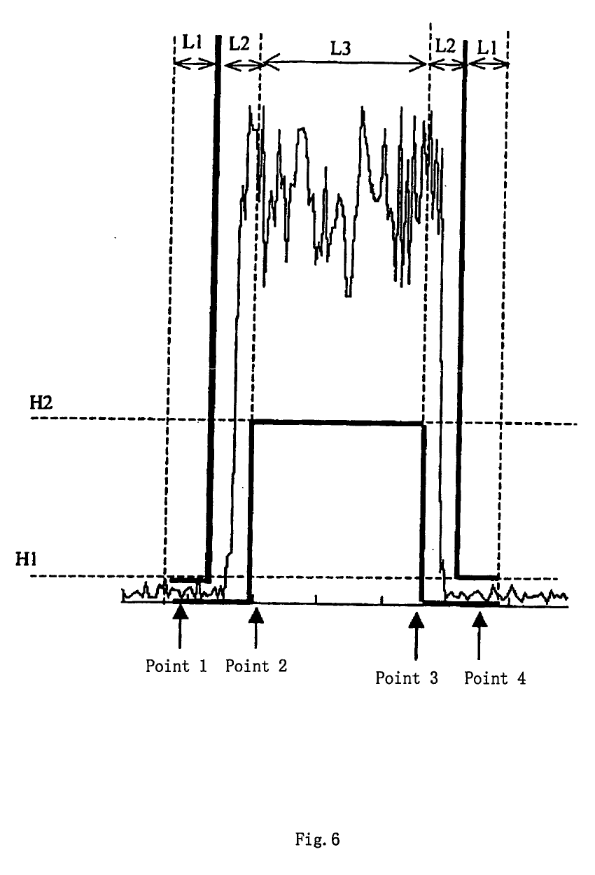

Following is the description of the method for mobile searching downlink synchronization signal SYNC_DL power pulse transmitted by base station. In order to search power pulse, a matched template is defined, which is used to compare with all the received signals. The better the two matches each other, the more probable that the received signal is the downlink synchronization signal SYNC_DL. FIG. 6 is an explanatory diagram showing a matched template of downlink synchronization signal SYNC_DL power pulse. The parameters of the matched templates are defined as follows:

H1 is the power threshold of guard period of the matched template, corresponding to the power of guard period of downlink synchronization signal SYNC_DL, namely the power of guard period of downlink synchronization signal should be smaller than H1;

H2 is the power threshold of SYNC_DL of the matched template, corresponding to the power of downlink synchronization signal SYNC_DL, namely the power of downlink synchronization signal SYNC_DL should be greater than H2;

L1 is the shortest length of guard period of the matched template, corresponding to the length of the guard period of downlink synchronization signal SYNC_DL, namely the length of guard period of downlink synchronization signal SYNC_DL should not be shorter than L1.

L2 is an interim, namely a period defined at both ends of SYNC_DL power pulse of the matched template. Taking into account the influence of multipath wireless transmission and the climbing/descending course of the amplifier, two interims with the length L2 are designed at both ends of the power pulse of the template. The power of interim will not be considered.

L3 is the length of SYNC_DL of the matched template, corresponding to the length of downlink synchronization signal SYNC_DL. It is obvious that L3 should be smaller than 64 code pieces and larger than (64−2*L2) code pieces.

Of course, these parameters can be adjusted according to specific situation.

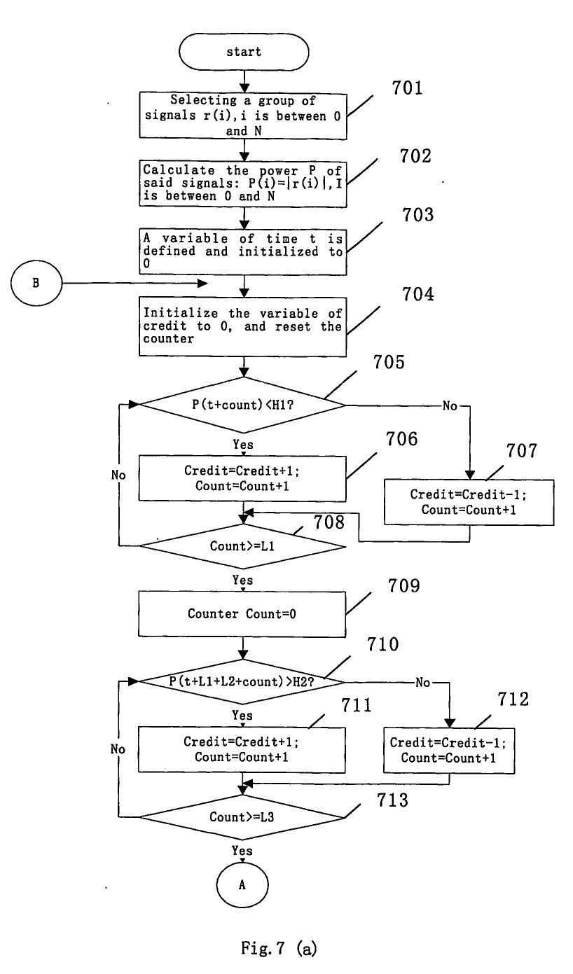

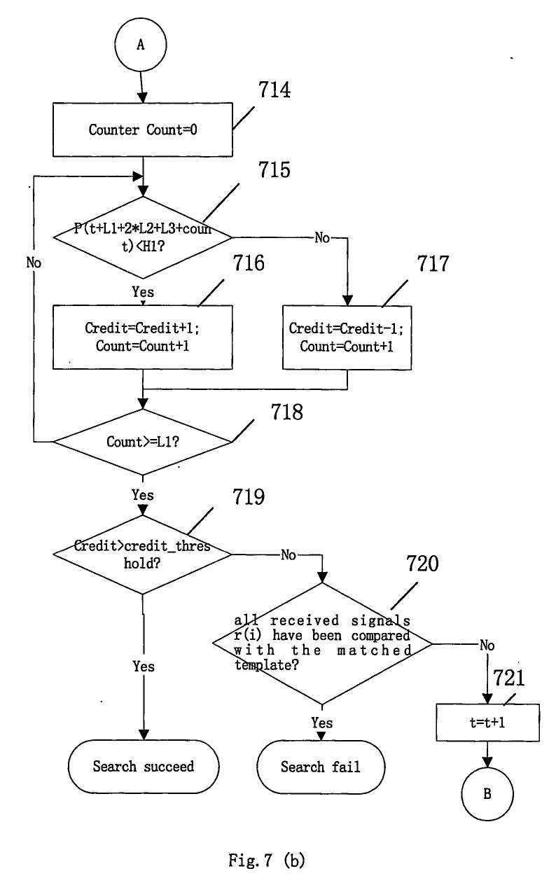

FIG. 7 is a flowchart showing a method for searching the downlink synchronization signal power pulse.

A group of signals r(i) are gathered from the signals received by the mobile terminal, wherein, the variable i, the sample time of a signal in this group, is defined between 0 and N(step 701).

Calculate the power P of received signals: P(i)=|r(i)|²; (step 702)

Define a time variable t and initialize it to 0; (step 703)

Initialize the variable of credit to 0, by which the comparability between the received signals r(i) and the match template is measured, and then reset the counter to 0 (step 704). Then, compare the signal r(i) with the match template, a value of credit can be achieved according to some particular rules. These rules are defined as follows:

First, detecting the guard period prior to signal pulse, which includes: comparing the signal pulse power P(k) with H1 (step 705), wherein, the value of k is defined between t and t+L1−1, if P(k) is smaller than H1, the variable of credit increases 1 (step 706); otherwise, the variable of credit decreases 1 (step 707). At the same time, the counter adds 1 after every comparison at every time point. When the value of the counter is greater than L1, the comparing operations in guard period are finished and the counter is reset to 0 (step 709).

Then, detecting signal pulse period, which includes: comparing the signal pulse power P(k) with H2 (step 710), wherein, the value of k is defined between t+L1+L2 and t+L1+L2+L3−1, if P(k) is higher than H1(step 711), the variable of credit increases 1; otherwise, the variable of credit decreases 1 (step 712). The counter adds 1 after every comparison at every time point. When the value of the counter is larger than L3, the comparing operations in the signal pulse period are finished and the counter is reset to 0 (step 713).

At last, checking the guard period post signal pulse, which includes: comparing the signal pulse power P(k) with H1(step 715), wherein, the value of k is defined between t+L1+2*L2+L3 and t+2*L1+2*L2+L3−1, if P(k) is lower than H1, the variable of credit increases 1 (step 716); otherwise, the variable of credit decreases 1 (step 717). The counter adds 1 after every comparison at every time point. When the value of the counter is larger than L1, the comparing operations in guard period are finished and the counter is reset to 0 (step 718).

A value of credit will be achieved after all the received signals are compared with the matched template. The larger the value of credit, the more similar is the signal to downlink synchronization signal SYNC_DL power pulse. In the present implemented example, the value of credit is between −2*L1−2*L2−L3 and 2*L1+2*L2+L3.

Later, judging by the variable of credit, if the value of the variable of credit is larger than the value of the specified threshold called credit_threshold (step 720), it is judged that the downlink synchronous signal SYNC_DL is found. Otherwise, it is considered that the downlink synchronous signal SYNC_DL has not been found and then enter the next judging process.

Judge whether all received signals r(i) have been compared with the match template (step 720). The standard is: if the sum time of the time variable t and the time needed for every full comparing operation is longer than N, it can be considered that all received signals r(i) have been compared with the matched template, in other words, comparing operation has been performed at every time point. If all received signals have been compared with the match template, it is considered that the downlink synchronous signal SYNC_DL power pulse has not been searched. Otherwise, set t=t+1 (step 721) and return to the step of initializing the variable of credit. Then, compare the signal r(i) at next time point with the matched template until all signals in the received group have been compared.

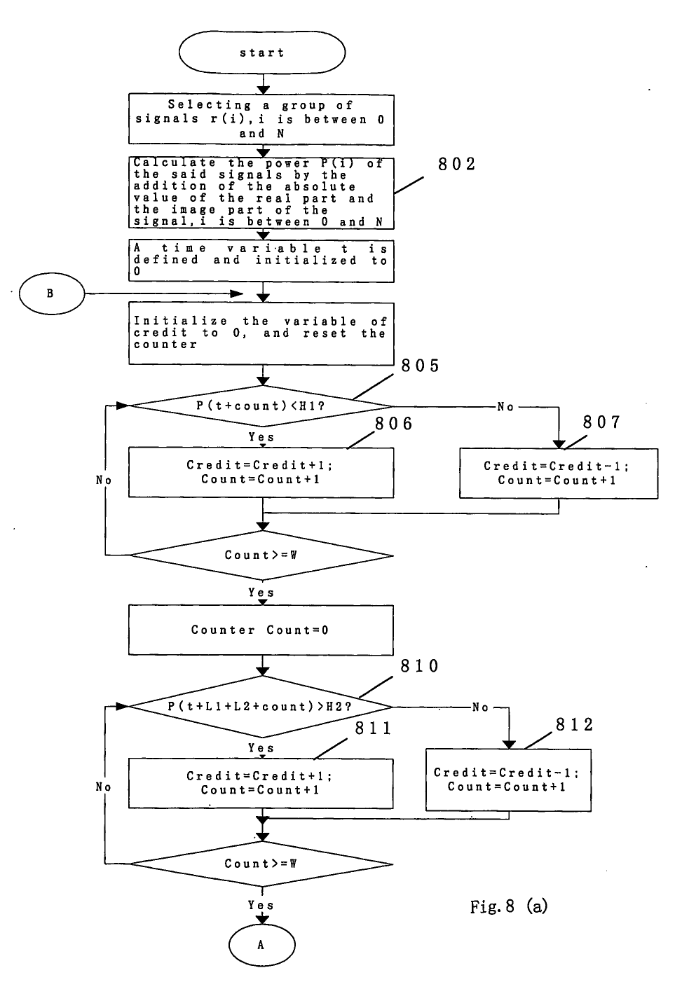

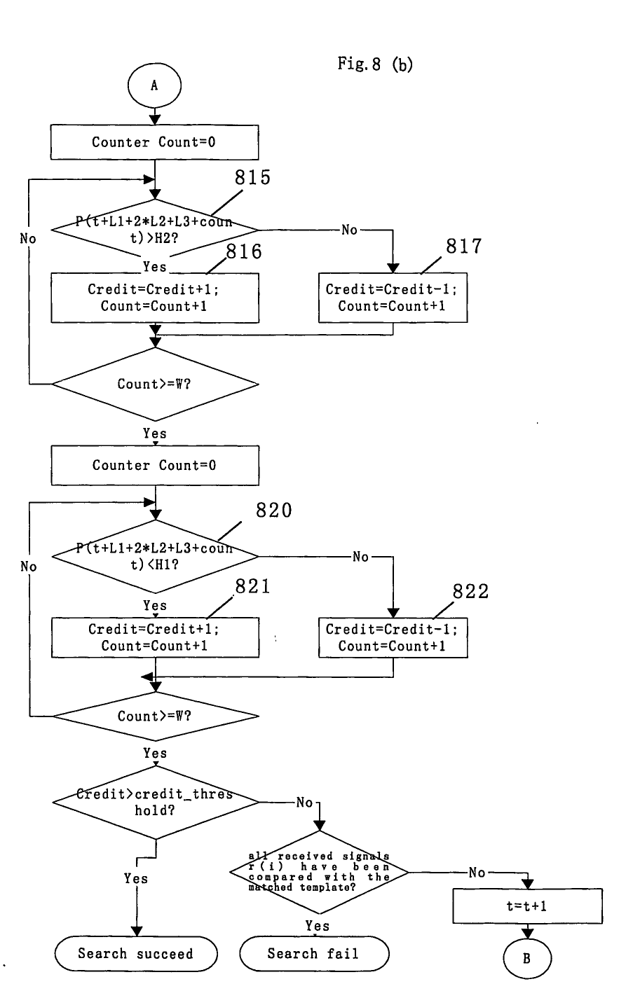

FIG. 8 is a simplified version of the method shown in FIG. 7, which can perform fast power pulse searching. The same parts of these two methods will not be repeated.

1. simplifying the power calculating operation (step 802). The following expression is used to represent the signal power:
P(i)=abs(real[r(i)])+abs(image[r(t)])
Wherein, real ( ) gets the real part of a complex number and image ( ) get the image part of a complex number. The result of this expression tells the intensity of the signal. Therefore, the application of this method avoids the square operation shown in FIG. 7, p (i)=|r (i)|².

2. simplifying matching operation. In the method shown in FIG. 7, all signals in the match template have been detected. Therefore, a complete pulse match operation requires a total number of 2*L1+L3 times' comparing operations. However, according to the earlier description of the structure of frames in TD_SCDMA system, the characteristics of downlink synchronous signal SYNC_DL power pulse can be simplified to be an ascending process and a descending process. Between which, there are 64 code pieces in the interval. Therefore, the difference between this method and the one shown in FIG. 7 is: only some special and important points will be tested in this method, namely detection point 1, detection point 2, detection point 3 and detection point 4. The rule for detecting SYNC_DL power pulse is simplified as follow:

Detecting the signal with W code pieces at detection point 1 (step 805), if the signal power is lower than H1, then credit increases 1 (step 806), otherwise, decreases 1 (step 807);

Detecting the signal with W code pieces at detection point 2 (step 810), if the signal power is higher than H2, then credit increases 1 (step 811), otherwise, decreases 1 (step 812);

Detecting the signal with W code pieces at detection point 3 (step 815), if the signal power is higher than H2, then credit increases 1 (step 816), otherwise, decreases 1 (step 817);

Detecting the signal with W code pieces at detection point 4 (step 820), if the signal power is lower than H1, then credit increases 1 (step 821), otherwise, decreases 1 (step 822);

Wherein, W is a parameter smaller than L1 and L3. When the comparison at the four points is completed, a value of credit will be achieved; the following steps will be the same as the method shown in FIG. 7.

The present invention can be realized by software, codes of the software can be storied in storage media, such as ROM, flash and so on.

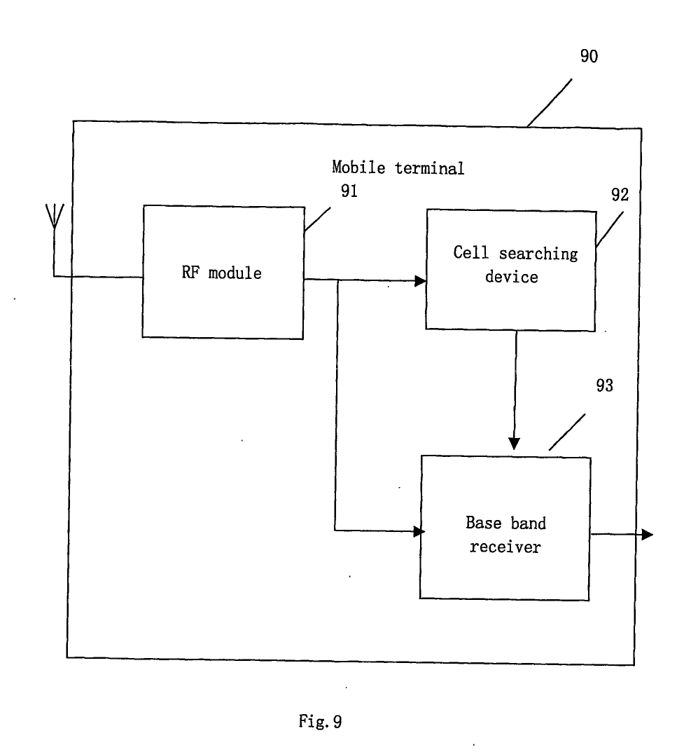

As shown in FIG. 9, the present invention also provides a kind of mobile terminal 90, including a searching device 92, which uses cell search in TDD-CDMA system to perform searching. The input port of the searching device is connected with a RF module 91 of the mobile terminal 90, and the output port of it is connected with a base band receiver 93. The mobile terminal 90 can perform fast cell search by the searching device 92, thereby setting and keeping synchronization with base station quickly.

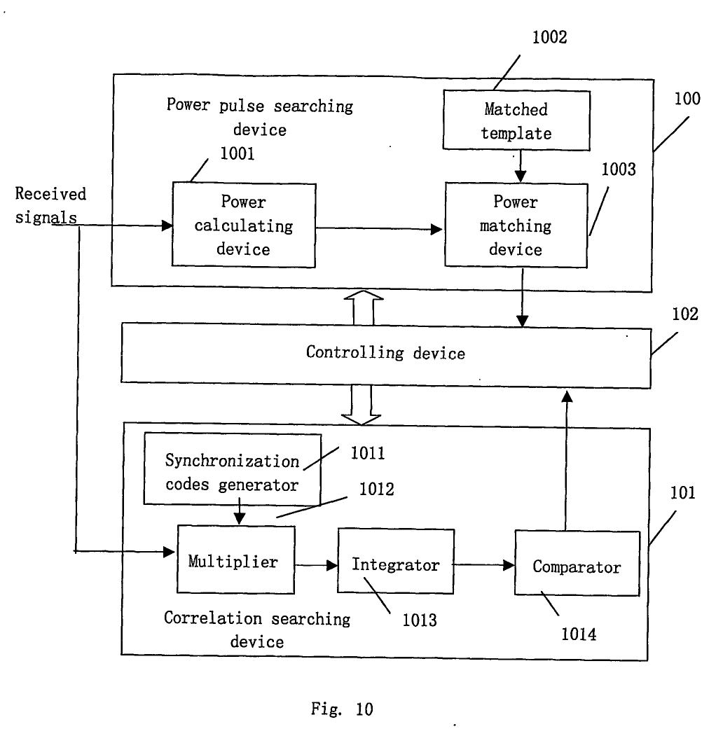

As shown in FIG. 10, the searching device also includes:

Power pulse searching device 100, correlation searching device 101 and controlling device 102.

The power pulse-searching device 100 is mainly used to get a coarse time synchronization parameter by searching the time synchronization power pulse. The searching device also includes a power calculating device 1001, a match template device 1002 and a power-matching device 1003. The power-calculating device 1001 is used to calculate the power of the received signal. The match template device 1002 is used to define and store the parameters of the power-matched template. The power-matching device 1003 is used to compare the degree of similarity between the power pulse of the received signals and the defined power match template.

The correlation-searching device 101 searches the time synchronization signal by correlation method to get precise time synchronization. It includes a synchronization code generator 1011, a multiplier 1012, an integrator 1013 and a comparator 1014. The synchronization code generator 1011 is used to generate local synchronization code and send the synchronization code to multiplier 1012 for multiplying with the received signal. The result of the multiplication is sent to the integrator 1013, and integrated in specified period. And then the result is sent to comparator 1014 for comparing with a specified threshold. The result of comparing is sent to the controlling device 102.

The controlling device 102 is used to control the work of the power pulse searching device 100 and correlation searching device 101, and to define their parameters.

The normal cell searching process of the mobile terminal is as follows:

1. The controlling device 102 activates the power pulse-searching device 100 and sets some corresponding work parameters (such as the parameters of the power matched template), to make the power pulse-searching device 100 begin to work.

2. The power pulse searching device 100 searches the time synchronization signal pulse defined by the match template and gets a coarse time synchronous parameter, and then sends the time synchronization signal parameter to the controlling device 102.

3. The controlling device opens a time searching window based on the coarse time parameter mentioned in step 2, and sends it to the correlation-searching device 101. At the same time, activates the time synchronization device (not shown), so that the time synchronization device begins to work.

4. The correlation-searching device does correlation searching in the time searching window mentioned in step 3 and gets precise time synchronization finally.

What is claimed is:

1. A cell searching method for mobile terminal in TDD-CDMA system, said method including the following steps:
a. searching the signal transmitted by base station according to pulse power;
b. if a signal being similar to the downlink synchronization signal is found successfully, a coarse time synchronization parameter will be gained;
c. based on the coarse time synchronization parameter, open a time searching window, and search for the downlink synchronous signals in the said time window; and
d. if it is failed in searching a downlink synchronous signal, search a downlink synchronous signal in the whole time period.

2. A method of claim 1, wherein step a includes the following steps:
a1. defining a match template;
a2. calculating the power of received signals;
a3. comparing all the received signals with the said match template.

3. A method of claim 2, wherein said match template's parameters are defined as follows:
H1 is the power threshold of guard period of the match template;
H2 is the power threshold of downlink synchronous signal of the match template;
L1 is the time of guard period of the match template;
L3 is the time of downlink synchronous signal of the match template.

4. A method of claim 2, wherein in step a2, the pulse power of the said signal can be achieved by adding the absolute value of the real part to the image part of the signal.

5. A method of claim 2, wherein step a3, also including a step of defining a variable of credit, which is used to measure the similarity between the received signals and match template.

6. A method of claim 5, wherein judging by the variable of credit, if the variable of credit touches the specified threshold, it is considered that the downlink synchronous signal is found.

7. A method of claim 2, wherein step a3 still includes following steps:
a3-1. detecting the guard period prior to signal pulse;
a3-2. detecting the signal pulse period;
a3-3. detecting the guard period post signal pulse.

8. A method of claim 7, wherein detecting the guard period prior to signal pulse includes: Comparing the signal pulse power with H1, if the signal pulse power is smaller than H1, the variable of credit increases a specified value; otherwise, the variable of credit decreases a specified value.

9. A method of claim 7, wherein detecting signal pulse period includes: Comparing the signal pulse power with H2, if the signal pulse power is higher than H1, the variable of credit increases a specified value; otherwise, the variable of credit decreases a specified value.

10. A method of claim 7, wherein checking guard period post signal pulse includes: Comparing the signal pulse power with H1, if the signal pulse power is lower than H1, the variable of credit increases a specified value; otherwise, the variable of credit decreases a specified value.

11. A method of claim 7, wherein during every pulse period of step a3, comparing the searched signal pulse power with the power of match template at every time point.

12. A method of claim 7, wherein during every pulse period of step a3, comparing the searched signal pulse power with the power of match template at the specified several detection points.

13. A mobile terminal including a searching device for performing cell search in TDD-CDMA system, wherein the searching device comprising:
a power pulse searching for getting a coarse time synchronous parameter by the signal emitted by pulse power searching base station;
a correlation searching means for opening a time searching window based on the coarse time synchronous parameter, and searching the downlink synchronous signals in the said time window; and
a controlling means for controlling the work of the power pulse searching means and correlation searching means and defining their parameters.

14. A mobile terminal of claim 13, wherein power pulse searching device includes:
power calculating device, which is used to calculate the power of the received signal;
match template device, which is used to define and store the parameters of the power match template; and
power matching device, which is used to compare the similarity between the power of the received signals and the power of the defined power match template.

15. A mobile terminal of claim 14, wherein the said power match template defines its parameters as follows:
H1 is the power threshold of guard period of the match template;
H2 is the power threshold of downlink synchronous signal of the match template;
L1 is the time of guard period of the match template;
L3 is the time of downlink synchronization signal of the match template.

16. A mobile terminal of claim 14, wherein the said power calculating device can achieve pulse power of the signal by adding the absolute value of the real part to the image part of the signal.

17. A mobile terminal of claim 14, wherein the said power matching device also defining a variable of credit, which is used to measure the similarity between the received signals and match template.

18. A mobile terminal of claim 14, wherein the said power matching device is judged by the variable of credit, if the variable of credit touches the specified threshold, it is judged that the downlink synchronous signal is found.

19. A mobile terminal of claim 14, wherein the said power matching device includes a detection device, which is used to detect the guard period prior to signal pulse the signal pulse period and the guard period post signal pulse.

20. A mobile terminal of claim 19, detecting guard period prior to signal pulse includes: Comparing the signal pulse power with H1, if the signal pulse power is smaller than H1, the variable of credit increases a specified value; otherwise, the variable of credit decreases a specified value.

21. A mobile terminal of claim 19, wherein detecting signal pulse period includes: comparing the signal pulse power with H2, if the signal pulse power is higher than H1, the variable of credit increases a specified value; otherwise, the variable of credit decreases a specified value.

22. A mobile terminal of claim 19, wherein check guard period post signal pulse includes:
Comparing the signal pulse power with H1, if the signal pulse power is lower than H1, the variable of credit increases a specified value; otherwise, the variable of credit decreases a specified value.

23. A mobile terminal of claim 19, wherein the said power matching device compares the searched signal pulse power with the power match template at every time point.

24. A mobile terminal of claim 19, wherein the said power matching device compares the searched signal pulse power with the power match template in the several specified detection point.
